(19) United States
(12) Patent Application Publication
(10) Pub. No.: US 2022/0113903 A1
(43) Pub. Date: Apr. 14, 2022

(54) SINGLE MEMORY BANK STORAGE FOR SERVICING MEMORY ACCESS COMMANDS

(71) Applicant: Micron Technology, Inc., Boise, ID (US)

(72) Inventor: Sanjay Subbarao, Irvine, CA (US)

(21) Appl. No.: 17/069,740

(22) Filed: Oct. 13, 2020

(51) Int. Cl. G06F 3/06

(52) U.S. Cl. CPC G06F 3/0659; G06F 3/0679; G06F 3/0604

(57) ABSTRACT

A method is described, which includes receiving a memory access command that requests access to data in a memory device and determining a location in the memory device for the memory access command. The location for the memory access command indicates a set of managed units in a row of a memory bank of the memory device. The memory access command is fulfilled using the data at the location as a complete response to the memory access command.

### TECHNICAL FIELD

The present disclosure generally relates to memory bank storage, and more specifically, relates to storing data for each memory access command in a single memory bank.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem, in accordance with some embodiments of the present disclosure.

FIG. 2 is a flow diagram of an example method to manage data in a set of memory devices, in accordance with some embodiments of the present disclosure.

FIG. 3 shows a memory configuration, including a memory controller managing data in a set of memory banks, in accordance with some embodiments of the present disclosure.

FIG. 4 shows an example in which a memory access command is directed at data stored in a row within a memory bank, in accordance with some embodiments of the present disclosure.

FIG. 5 shows another example in which multiple memory access commands are directed at data stored in rows within separate memory banks, in accordance with some embodiments of the present disclosure.

FIG. 6 is a block diagram of an example computer system in which embodiments of the present disclosure may operate.

### DETAILED DESCRIPTION

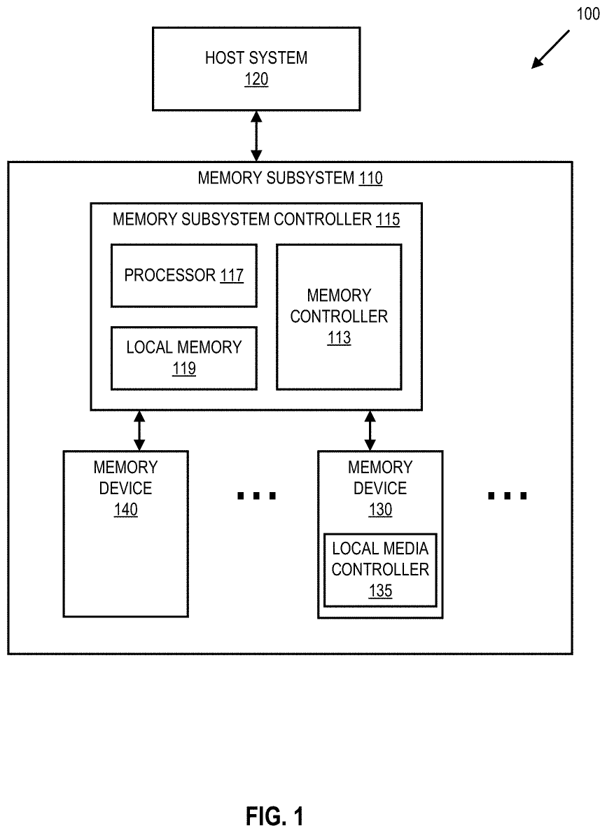

Aspects of the present disclosure are directed to management of data in memory devices, including storing data used for fulfilling memory access commands in a single memory bank of the memory devices to increase performance of the memory device. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored at the memory subsystem and can request data to be retrieved from the memory subsystem.

A memory device can be a non-volatile memory device. A non-volatile memory device is a package of one or more dice. One example of non-volatile memory devices is a negative-and (NAND) memory device. Other examples of non-volatile memory devices are described below in conjunction with FIG. 1. The dice in the packages can be assigned to one or more channels for communicating with a memory subsystem controller. Each die can consist of one or more planes. Planes can be grouped into logic units (LUN). For some types of non-volatile memory devices (e.g., NAND memory devices), each plane consists of a set of physical blocks, which are groups of memory cells to store data. A cell is an electronic circuit that stores information.

Depending on the cell type, a cell can store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MLCs), triple-level cells (TLCs), and quad-level cells (QLCs). For example, an SLC can store one bit of information and has two logic states.

Memory subsystems, such as those that manage main memory (e.g., Double Date Rate (DDR) memory) and storage class memory (e.g., NAND memory devices), can require data to be striped across memory parts/banks. For example, a memory device of a memory subsystem can include a set of nine memory parts and each memory part can include a set of four memory banks (sometimes referred to as parallel banks), which is itself arranged into rows and columns of managed units. In this configuration, the memory device includes thirty-six memory banks split evenly across the nine memory parts. To access data within a memory bank, a memory controller must activate a row within a corresponding memory bank. Although each memory part can handle simultaneous access to separate memory banks, including reading and writing data from each memory bank, each memory bank only permits activation and corresponding access to a single row within the memory bank. Accordingly, before accessing data (i.e., data within a managed unit) in any particular row within a memory bank, all other rows must be closed/deactivated such that the row of interest can be opened/activated.

A memory controller manages access to memory parts, including reading and writing data. For example, a memory controller can receive a memory access command (sometimes referred to as a memory access request or a memory request) from a host system for access to data stored within managed units of a set of memory banks. As used herein, a managed unit is a basic unit of memory access that each memory access command is seeking to access. In particular, a managed unit can be 8-bytes, 16-bytes, 32-bytes, 64-bytes, 72-bytes, etc. and the memory access command can be directed to some number of managed units. For example, a memory access command can seek to access 64 bytes of user data and 8 bytes of parity data/information, which is used for error correction on the 64 bytes of user data. When data is striped across multiple memory banks, the memory controller divides the user and parity data across the multiple memory banks. For example, when a memory access command seeks to write 64 bytes of user data and 8 bytes of parity data (a total of 72 bytes) to a memory device managed by the memory controller, the memory controller divides the 72 bytes of data amongst a set of memory banks instead of writing the entire 72 bytes of data to a single row in a single memory bank. For instance, the memory controller can write 8 bytes to a memory bank in each of the nine memory parts of the memory device described above. To stripe data across the nine memory parts and memory banks in this fashion requires the issuance of row activation commands for each of the nine memory banks such that a memory access command (e.g., a read or write operation) can be performed on each corresponding row. Accordingly, a single memory access command results in significant command amplification when data being accessed is striped across multiple memory parts and corresponding memory banks. In particular, in the example provided above, a single memory access command results in nine row activation commands for nine separate memory banks (i.e., a command amplification of 9×).

Further, since a single memory access command results in data being read or written from/to nine separate memory banks and each memory bank can only facilitate a single access at a time (since only a single row can be activated at a time), as memory access commands begin to accumulate/queue in the memory controller, the probability of a memory bank collision (i.e., two memory access commands that seek to access the same memory bank) increases. For instance, in the example above in which there are thirty-six memory banks in a memory device (i.e., four memory banks in each of nine memory parts) and 72 bytes of data are evenly striped across nine memory banks, a single memory access command occupies one-quarter of the memory banks (e.g., nine of the thirty-six memory banks). Accordingly, a subsequent memory access command that seeks to access data in any one of these memory banks must be delayed. In an optimal situation, the memory controller and memory device can simultaneously handle four memory access commands. However, this optimal situation requires each of the four memory commands to access data in set of non-overlapping memory banks, which can be a rare/improbable occurrence.

Memory subsystems designed to stripe data across memory banks seek to efficiently process memory access commands that are directed to serial memory addresses. Namely, these memory subsystems assume that memory access commands that are serially processed are targeted at adjacent addresses/locations or at least memory locations in the same row of a memory bank. In this fashion, a single row activation can be performed to fulfill multiple, serial memory access commands. This approach attempts to saturate the bandwidth of a memory bus by exploiting memory bank interleaving (e.g., activation of multiple rows in multiple memory banks simultaneously) and open page hits. However, it is more common to receive non-serial memory access commands (e.g., memory access commands that are directed at non-serial locations/addresses). For instance, processes associated with artificial intelligence and search routines often request data from non-serial/random memory addresses/locations, which would be located outside a single row of a memory bank. Accordingly, the time-intensive task of opening a row needs to be incurred before the comparatively quicker task of accessing data can be performed. With heavy memory bank collisions, delays caused by these collisions are exacerbated, as all pending memory requests need to wait for rows to be activated for currently processed memory requests.

On the basis of various factors associated with striping data across memory banks, including command amplification and memory bank collisions, the performance of the memory subsystem is compromised. Namely, the number of memory access commands that the memory controller and the memory device can process during a specified time period is reduced based on overhead and inefficiencies associated with striping data across memory banks. In some cases, this overhead and associated inefficiencies can result in a reduction of performance of up to 90% from the capabilities of a memory controller and corresponding memory device (i.e., the maximum number of memory access commands that a memory controller and corresponding memory device will handle is 10% of the capabilities of these devices).

Aspects of the present disclosure address the above and other deficiencies by storing each segment of data sought by a memory access command in a single row of a single memory bank in a single memory part of a single memory device. Accordingly, to entirely/completely fulfill/process a memory access command received from a host system or otherwise generated by the memory controller, a memory controller that manages the memory device activates a single row of a single memory bank and without activation/access to any other row in the memory device or any other memory device (e.g., without activating or accessing another row in another memory bank). This allows each memory bank of each memory part within a memory device to be available for fulfillment of separate memory access commands. For instance, in the example above in which a memory device includes nine memory parts and each memory part includes four memory banks, a memory controller can simultaneously access each memory bank from each memory part (e.g., simultaneously access thirty-six memory banks) to fulfill thirty-six corresponding memory access commands. In comparison, when each managed unit is striped across separate memory banks in separate memory parts such that multiple memory banks and memory parts are needed to fulfill a single memory access command, at most four memory access commands can be processed/fulfilled simultaneously (assuming ideal conditions in which no memory access command requires access to a same memory bank). By maintaining all data needed to fulfill a single memory access command in a single row of a single memory bank, the memory controller relies on only a single memory bank to fully process/fulfill a memory access command. This configuration, in which a memory access command can be fulfilled through activation of a single row in a single memory bank, (1) prevents command amplification in which a single memory access command requires activation of multiple rows, as only a single row needs to be activated, (2) reduces the likelihood of collisions in which multiple memory access commands seek to access the same memory bank, as each memory access command is associated with a single memory bank instead of multiple (e.g., nine) memory banks, and (3) improves memory access command fulfillment performance and consequent memory access command latency since, with reduced collisions, the memory controller can simultaneously process/fulfill many more memory access commands with minimal delay. Accordingly, the number of memory access commands capable of being processed in a discrete period of time (e.g., the number of memory access commands that can be processed per second) can be increased by (1) reducing overhead associated with each memory access command (e.g., reduce/eliminate command amplification), (2) reducing delays caused by collisions, and (3) increasing the number of memory access commands that can be processed/fulfilled simultaneously. Additional details of these techniques will be described in further detail below.

FIG. 1 illustrates an example computing system 100 that includes a memory subsystem 110 in accordance with some embodiments of the present disclosure. The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory subsystem 110. The host system 120 can further utilize an NVM Express (NVMe) interface to access components (e.g., memory devices 130) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via a same communication connection, multiple separate communication connections, and/or a combination of communication connections.

The memory devices 130,140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in a local memory 119. In the illustrated example, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processor or controller separate from the memory subsystem 110).

In general, the memory subsystem controller 115 can receive commands or operations from the host system 120 and can convert the commands or operations into instructions or appropriate commands to achieve the desired access to the memory device(s) 130 and/or the memory device 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory subsystem controller 115 can further include host interface circuitry to communicate with the host system 120 via the physical host interface. The host interface circuitry can convert the commands received from the host system into command instructions to access the memory devices 130 and/or the memory device 140 as well as convert responses associated with the memory devices 130 and/or the memory device 140 into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices 130.

In some embodiments, the memory devices 130 include local media controllers 135 that operate in conjunction with memory subsystem controller 115 to execute operations on one or more memory cells of the memory devices 130. An external controller (e.g., memory subsystem controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory subsystem 110 includes a memory controller 113 that can fulfill memory access commends (e.g., read and write commands) using a single row in a single memory bank. In some embodiments, the controller 115 includes at least a portion of the memory controller 113. For example, the controller 115 can include a processor 117 (processing device) configured to execute instructions stored in local memory 119 for performing the operations described herein. In some embodiments, a memory controller 113 is part of the host system 110, an application, or an operating system.

The memory controller 113 can fulfill memory access commends (e.g., read and write commands) using a single row in a single memory bank. Further details with regards to the operations of the memory controller 113 are described below.

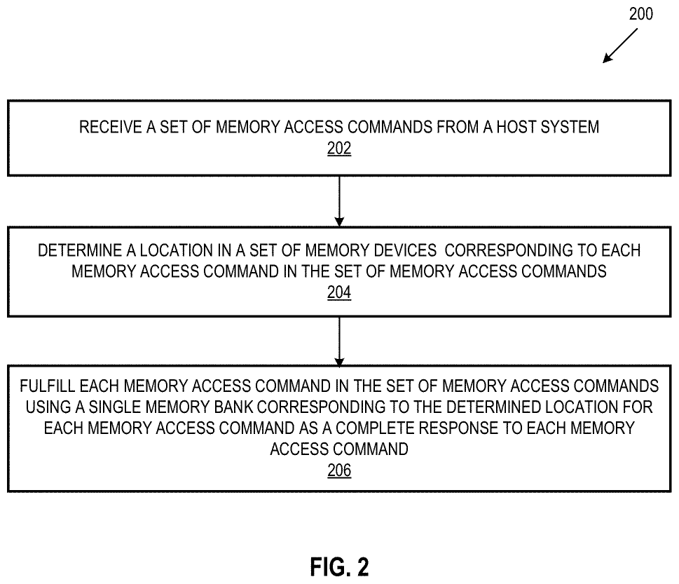

FIG. 2 is a flow diagram of an example method 200 to manage data in a set of memory devices 130, in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the memory controller 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

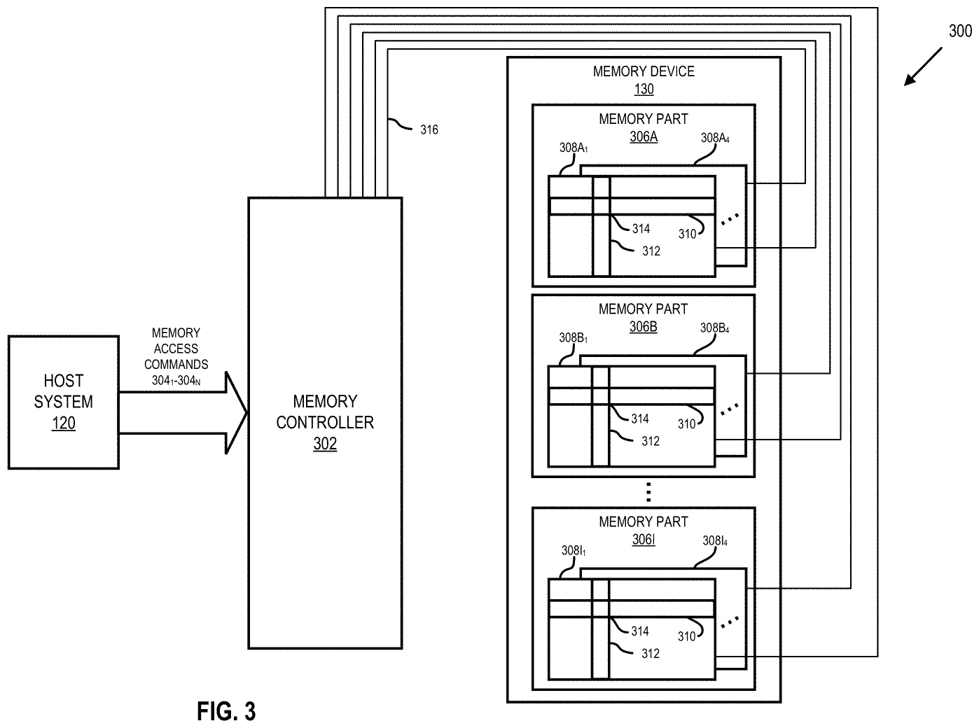

At operation 202, the processing device can receive a set of memory access commands from a host system 120. For example, FIG. 3 shows a memory configuration 300, in accordance with some embodiments of the present disclosure. As shown in FIG. 3, the memory configuration 300 includes a memory controller 302 that receives a set of memory access commands 304₁-304_{N} from the host system 120. As shown in FIG. 3, in some embodiments, the memory controller 302 is outside the host system 120 and the memory controller 302 is coupled to the host system 120 through a bus. For example, the memory controller 302 is coupled to the host system 120 through a peripheral interconnect bus of a processor of the host system 120 (e.g., the Peripheral Component Interconnect Express (PCIe) Compute Express Link (CXL)) instead of a memory slot (e.g., a non-volatile dual in-line memory module (NVDIMM) slot or a double data rate (DDR) slot) of the host system 120. In this fashion, the memory controller 302 can bypass a memory controller integrated in processor of the host system 120. In one embodiment (and for the purpose of describing the method 200), the memory controller 302 is the memory controller 113 of the memory subsystem 110. Although shown in FIG. 3 as the memory controller 302 being outside of the host system 120, in some embodiments the memory controller 302 can be integrated within the host system 120. For example, the host system 120 can be/include a processing device (e.g., a central processing unit (CPU), graphics processing unit (GPU), system on a chip (SOC), etc.) with integrated memory (e.g., a cache hierarchy, including one or more of a level one (L1) cache and a level two (L2) cache). In either case (i.e., the memory controller 302 being inside or outside of the host system 120), in response to a miss in the integrated memory of the host system 120 or a flush or clean from the integrated memory of the host system 120, the memory controller 302 may receive the set of memory access commands 304₁-304_{N} directed at the memory device 130 at operation 202. In the case of a miss, the set of memory access commands 304₁-304_{N} can include one or more of a read command, which seeks to read data from the memory components 130, and a write command, which seeks to write data that has been evicted from the integrated memory to the memory devices 130 to make room for the newly read data.

Although described in relation to receiving each of the memory access commands 304 concurrently/simultaneously, in some embodiments, two or more memory access commands 304 from the set of memory access commands 304₁-304_{N} can be received (1) during separate (potentially overlapping) time periods and/or (2) in relation to separate stimuli (e.g., separate read and/or write commands that correspond to separate flushes). Accordingly, at operation 202, the memory controller 113 can receive memory access commands 304 that are separated by time and/or are unrelated to each other.

As noted above, the set of memory access commands 304₁-304_{N} seek to access data stored in the memory devices 130. For example, the memory access command 304₁ can seek to access 64 bytes of user data (e.g., data used for a video, artificial intelligence, a search application, etc.) stored in the memory devices 130. To ensure the 64 bytes of user data does not contain errors, the memory access command 304₁ can also retrieve 8 bytes of parity data, such that a total of 72 bytes of data is retrieved from the memory device 130 in response to the memory access command 304₁. Each of the other memory access commands 304 in the set of memory access commands 304₁-304_{N} can be similarly directed to 64 bytes of user data and 8 bytes of corresponding parity data. Although described as including 64 bytes of user data and 8 bytes of parity data, in some embodiments, the data retrieved in response to each memory access command 304 can include more or less user data (e.g., 8 bytes, 32 bytes, or 128 bytes of user data) and more or less parity data (e.g., 0 bytes or 16 bytes of parity data). Accordingly, the use of 64 bytes of user data and 8 bytes of parity data is for illustrative purposes.

At operation 204, the memory controller 113 determines a location in the memory devices 130 corresponding to each memory access command 304 in the set of memory access commands 304₁-304_{N}. In some embodiments, each memory device 130 is divided into a set of memory parts, each memory part is subdivided into a set of memory banks, and each memory bank is arranged into rows and columns. In this configuration, at the location/cross-section defined by a row and column in a memory bank is a single managed unit. For example, FIG. 3 shows a single memory device 130 with a set of nine memory parts 306A-306I. Each memory part 306 in the set of nine memory parts 306A-306I includes a set of four memory banks 308 (e.g., the memory part 306A includes the memory banks 308A₁-308A₄, the memory part 306B includes the memory banks 308B1-308B₄, . . . and the memory part 306I includes the memory banks 308I₁-308I₄). As noted above, managed units 314 are located at the intersection of rows 310 and columns 312. For example, memory controller 302 can activate a row 310 in the memory bank 308A₁ to access data in a managed unit 314 at a particular column 312 within the activated row 310. The size of the managed units 314 in the memory banks 308 corresponds to the size of the smallest addressable units within the memory configuration 300. For example, the managed units 314 can be 4-bytes, 8-bytes, 16-bytes, 32-bytes, or 64-bytes of data. In this configuration, each memory access command 304 seeks to access (e.g., read or write) user data in some set of managed units 314 in a memory bank 308. In some embodiments, each managed unit 314 can be equally sized to the data sought by each memory access command 304 (e.g., each of the memory access commands 304 can seek to access 64 bytes or 72 bytes of data and the managed units 314 can be 64-bytes or 72-bytes, respectively) while in other embodiments, each managed unit 314 can be smaller in size than the data sought by each memory access command 304 (e.g., each of the memory access commands 304 can seek to access 64 bytes or 72 bytes of data and the managed units 314 can be 8-bytes). In some embodiments, the managed units 314 may additionally store parity data/bits that are used for performing error correction on user data stored in the memory components 130. Accordingly, although a memory access command 304 can seek to access 64 bytes of user data (e.g., read or write 64 bytes of user data), the managed units 314 can store 72 bytes of data, with the additional 8 bytes being used as parity data. At operation 204, the processing device determines which locations (e.g., locations/addresses of managed units 314) are to be accessed to fulfill each memory access command 304 in the set of memory access commands 304₁-304_{N}. For example, the memory access command 304₁ can be directed at a set of managed units 314 located in the memory component 130, in the memory part 306A, in the memory bank 308A, in a particular row 310 and a particular column 312 within the memory bank 308A. This location can be indicated by a corresponding address in the memory access command 304₁. Accordingly, the memory controller 302 determines that the data to fulfill the memory access command 304₁ is entirely located in a single row 310 in the memory bank 308A (i.e., a single location). In contrast, when data is striped across several memory banks 308, the memory controller 302 would need to determine a location for each corresponding memory bank 308.

At operation 206, the processing device entirely/completely fulfills each of the memory access commands 304 (e.g., read user data is returned to the host system 120 and/or user data with parity data is written to memory) in the set of memory access commands 304₁-304_{N} using a single row 310 in a single memory bank 308 corresponding to the determined location for each memory access command 304 (i.e., each memory access command 304 is entirely/completely fulfilled with access to a single row 310 in a single memory device 130 and without access to another row 310 in a memory bank 308 of the memory device 130 or another memory device 130). Fulfillment of the memory access commands 304 can include activating corresponding rows 310 in corresponding memory banks 308 based on the determined location. In particular, the memory controller 302 needs to activate a row 310 in a memory bank 308 corresponding to the determined location before the memory controller 302 can access data (e.g., read from or write to a set of managed units 314) in the memory bank 308. However, only a single row 310 in each memory bank 308 can be activated at any point in time. Thus, for a current memory access command 304, the memory controller 302 determines whether a row 310 for this memory access command 304 is already activated in a corresponding memory bank 308 or, when the row 310 is not yet activated, whether any other row 310 in the memory bank 308 is activated and being used such that the memory controller 304 cannot activate the row 310 for the current memory access command 304. When the memory controller 302 cannot activate a row 310 because of an already activated row 310 in the memory bank 308, a collision has occurred and the current memory access command 304 is delayed.

As shown in FIG. 3, the memory controller 302 can independently signal each memory bank 308 using a set of signaling lines/pins 316 that are communicatively coupled to corresponding memory banks 308. In particular, when data for each memory access command 304 is striped across multiple memory banks 308, the memory controller 302 can commonly signal each corresponding row 310 in each memory bank 308 to activate these rows 310. However, although this signaling is efficient in terms of using a single line/pin, it leads to command amplification as a single memory access command 304 results in multiple row activation commands to fulfill the single memory access command 304. In contrast, when data for a single memory access command 304, including both user data and parity data, is stored in a single row 310 of a single memory bank 308, only a single row activation command is needed to fulfill the memory access command 304. For example, in the example above in which nine rows 310 and corresponding memory banks 308 are needed to fulfill a single memory access command 304 when data for the memory access command 304 is striped across memory banks 308, a single memory access command 304 requires nine row activation commands. In comparison, when all data for a memory access command 304 is included in a single row 310 of a single memory bank 308, a single memory access command 304 requires one row activation command. Accordingly, this results in a command reduction of 9× in comparison to the striped storage case.

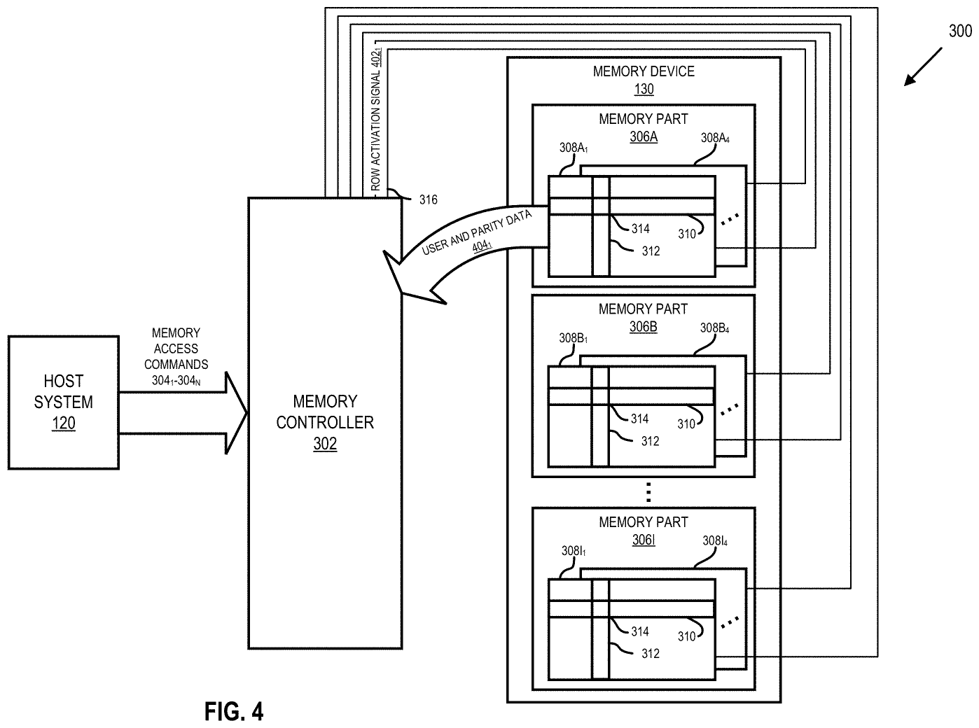

As described herein, each memory access command 304 is directed at a single row 310 in a single memory bank 308. Accordingly, based on the determined location the memory controller 302 activates a row 310 in a single memory bank 308 to fulfill a single memory access command 304. FIG. 4 shows an example in which the memory access command 304₁ is directed at data stored in a row 310 within the memory bank 308A₁ (i.e., a single location in the memory device 130). Accordingly, the memory controller 302 transmits a row activation signal 402₁ to the corresponding row 310 in the memory bank 308A₁ to access user data and parity data 404₁ stored therein. The memory controller 302 can use the parity data to perform error correction on the user data and return the error corrected user data to the host system 120 as a response to the memory access command 304₁. Accordingly, the memory controller entirely/completely fulfills the memory access command 304₁ based on access to a single row 310 in a single memory bank 308 and without access to any other rows 310, in any other memory banks 308, in any other memory parts 306, in any other memory device 130 (e.g., without activating or accessing another row 310 in another memory bank 308).

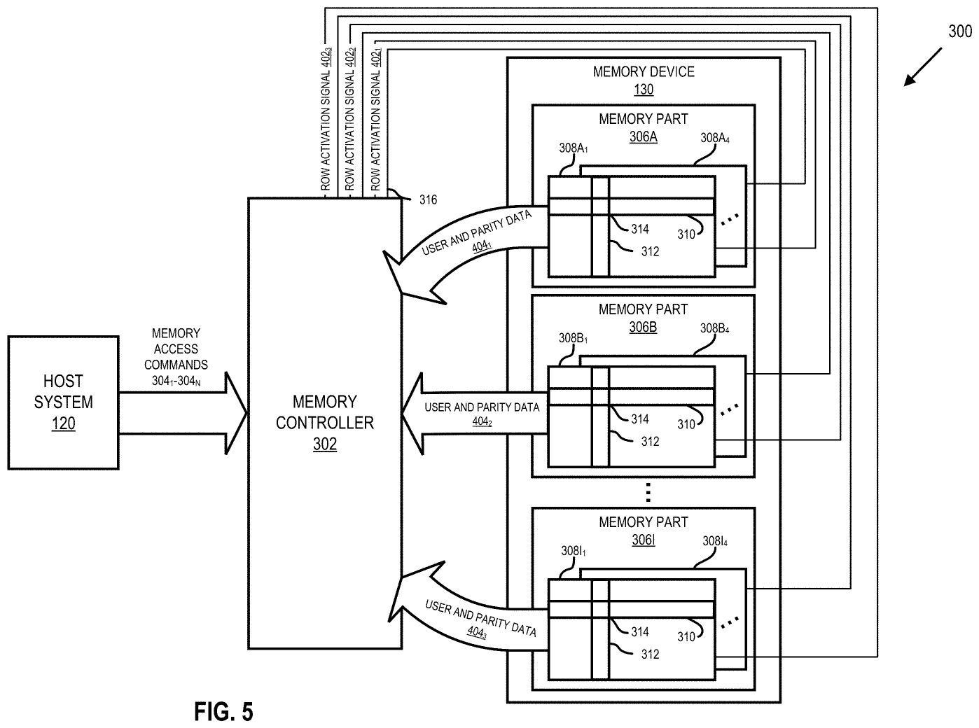

FIG. 5 shows another example in which the memory access command 304₁ is directed at data stored in a row 310 within the memory bank 308A₁, the memory access command 3042 is directed at data stored in a row 310 within the memory bank 308B₁, and the memory access command 304₃ is directed at data stored in a row 310 within the memory bank 308I₁. Accordingly, the memory controller 302 transmits (1) a row activation signal 402₁ to the corresponding row 310 in the memory bank 308A₁ to access user data and parity data 404₁ stored therein, (2) a row activation signal 402₂ to the corresponding row 310 in the memory bank 308B₁ to access user data and parity data 404₂ stored therein, and (3) a row activation signal 402₃ to the corresponding row 310 in the memory bank 308I₁ to access user data and parity data 404₃ stored therein. For each case, the memory controller 302 can use the parity data to perform error correction on the user data and return the error corrected user data to the host system 120 as respective responses to the memory access commands 304₁-304₃. Accordingly, the memory controller entirely/completely fulfills each of the memory access command 304₁-304₃ based on access to a single row 310 in a single memory bank 308 and without access to any other rows 310, in any other memory banks 308, in any other memory parts 306, in any other memory device 130 in each respective case. Although not shown, the procedure described above can apply to each of the memory banks 308 such that the memory controller 302 can simultaneously fulfill a number of memory access commands 304 equal to the number (M) of memory banks 308 in the memory device 130 (i.e., the memory controller 302 can simultaneously fulfill M memory access commands). In the case of the configuration 300, the memory controller 302 can simultaneously fulfill thirty-six memory access commands 304 as there are thirty-six memory banks 308 in the memory device 130.

In comparison to techniques in which data for a single memory access command 304 is striped across multiple memory banks 308, by maintaining data for each memory access command 304 in a single memory bank 308, the method 200 and the configuration 300 described herein can (1) prevent command amplification in which a single memory access command 308 requires activation of multiple rows 310 in multiple memory banks 308 as all data of a memory access command 304 requires activation of a single row 310 in a single memory bank 308, (2) reduce the likelihood of collisions in which multiple memory access commands 304 seek to access the same memory bank 308 since all data of a memory access command 304 requires activation of a single row 310 in a single memory bank 308, and (3) allow the memory controller 302 to simultaneously process/fulfill numerous memory access commands 304 since a single memory access command 304 does not require the use of a memory bank 308 in each or multiple memory parts 306, which would consequently block and delay all other memory access commands 304 seeking to access any one of those memory banks 308. For example, for a memory access command 304 that seeks to read or write 72 bytes of data, including 8 kilobytes of parity data, when data is striped across separate memory banks 308 in each memory part 306 (e.g., 8 bytes of data for the memory access command 304 is stored in a memory bank 308A, 8 bytes of data for the memory access command 304 is stored in a memory bank 308B, . . . , and 8 bytes of data (e.g., parity data/information) for the memory access command 304 is stored in a memory bank 308I), fulfilling this memory access command 304 requires the activation of nine rows 310 in nine separate memory banks 308. Accordingly, this use of multiple memory banks 308 to fulfill a single memory access command 304 will block those memory banks 308 from being used for processing/fulfilling other memory access commands 304 and will result in command amplification (e.g., 9× command amplification). In contrast, by storing the data for each memory access command 304 in a single memory bank 308, the method 200 and configuration 300 prevents increases efficiency of the memory access command processing by the memory controller 302.

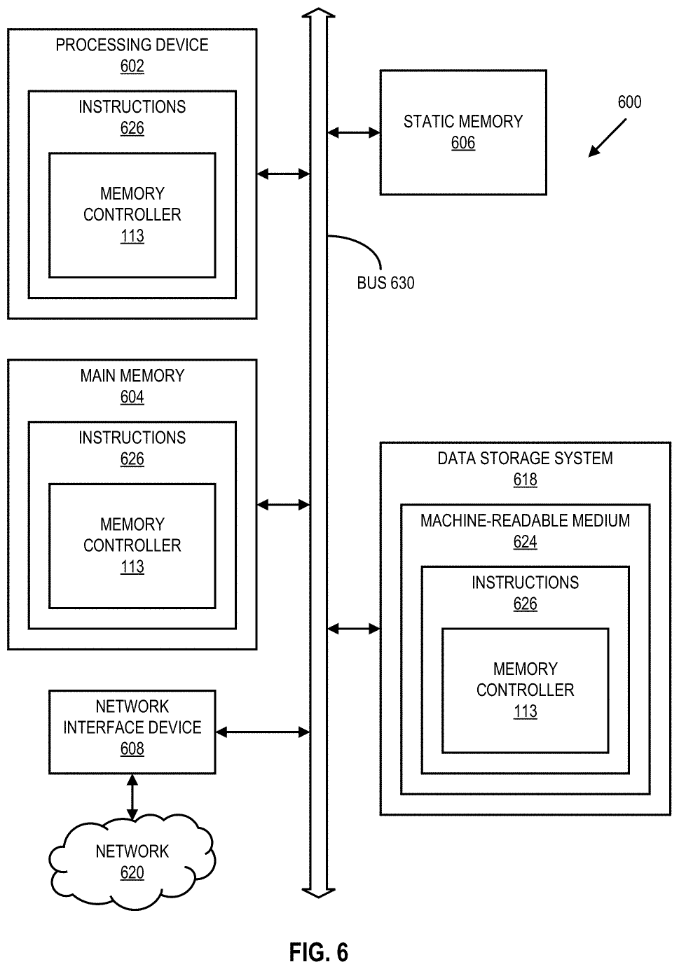

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the memory controller 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory subsystem 110 of FIG. 1.

In one embodiment, the instructions 626 include instructions to implement functionality corresponding to a memory controller (e.g., the memory controller 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the controller 115, may carry out the computer-implemented method 200 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving a first memory access command that requests access to first data in a memory device;
determining a first location in the memory device for the first memory access command, wherein the first location for the first memory access command indicates a set of managed units in a first row of a first memory bank of the memory device; and
fulfilling the first memory access command using the first data at the first location as a complete response to the first memory access command.

2. The method of claim 1, wherein the memory device is divided into a set of memory parts, each memory part in the set of memory parts is subdivided into a set of memory banks, and each memory bank in the set of memory banks of each memory part is arranged into rows and columns of managed units.

3. The method of claim 1, wherein the first memory access command is one of a read memory command or a write memory command.

4. The method of claim 1, wherein fulfilling the first memory access command comprises:
activating the first row in the first memory bank;
accessing the first data in the first row of the first memory bank, wherein accessing the first data includes one of reading the first data from the first row or writing the first data to the first row; and
when the accessing includes reading the first data from the first row, including first user data and first parity data stored together in the first row, and returning the first user data to a host system as the complete response to the first memory access command.

5. The method of claim 4, further comprising:
receiving a second memory access command that requests access to second data in the memory device;
determining a second location in the memory device for the second memory access command, wherein the second location for the second memory access command indicates a set of managed units in a second row of a second memory bank of the memory device; and
fulfilling the second memory access command using the second data at the second location as a complete response to the second memory access command.

6. The method of claim 5, wherein fulfilling the second memory access command comprises:
activating the second row in the second memory bank;
accessing the second data in the second row of the second memory bank, wherein accessing the second data includes one of reading the second data from the second row or writing the second data to the second row; and
when the accessing includes reading the second data from the second row, including second user data and second parity data stored together in the second row, and returning the second user data to the host system as the complete response to the second memory access command.

7. The method of claim 6, wherein the memory device includes N memory banks and fulfilling the first and second memory access commands is performed during an overlapping time period with fulfilling N−2 other memory access commands in relation to N−2 other memory banks in the memory device.

8. A system comprising:
a memory device; and
a processing device, operatively coupled with the memory device, to:
receive a first memory access command that requests access to first data in the memory device;
determine a first location in the memory device for the first memory access command, wherein the first location for the first memory access command indicates a set of managed units in a first row of a first memory bank of the memory device; and
fulfill the first memory access command using the first data at the first location as a complete response to the first memory access command without access to another location in another row in the memory device or another memory device.

9. The system of claim 8, wherein the memory device is divided into a set of memory parts, each memory part in the set of memory parts is subdivided into a set of memory banks, and each memory bank in the set of memory banks of each memory part is arranged into rows and columns of managed units.

10. The system of claim 8, wherein the first memory access command is one of a read memory command or a write memory command.

11. The system of claim 8, wherein fulfilling the first memory access command comprises:
activating the first row in the first memory bank;
accessing the first data in the first row of the first memory bank, wherein accessing the first data includes one of reading the first data from the first row or writing the first data to the first row; and
when the accessing includes reading the first data from the first row, including first user data and first parity data stored together in the first row, and returning the first data to a memory subsystem controller as the complete response to the first memory access command without access to another location in the memory device or another memory device.

12. The system of claim 11, wherein the processing device is further to:
receive a second memory access command that requests access to second data in the memory device;
determine a second location in the memory device for the second memory access command, wherein the second location for the second memory access command indicates a set of managed units in a second row of a second memory bank of the memory device; and
fulfill the second memory access command using the second data at the second location as a complete response to the second memory access command without access to another location in the memory device or another memory device.

13. The system of claim 12, wherein fulfilling the second memory access command comprises:
activating the second row in the second memory bank;
accessing the second data in the second row of the second memory bank, wherein accessing the second data includes one of reading the second data from the second row or writing the second data to the second row; and
when the accessing includes reading the second data from the second row, including second user data and second parity data stored together in the second row, returning the second data to the memory subsystem controller as the complete response to the second memory access command.

14. The system of claim 13, wherein the memory device includes N memory banks and fulfilling the first and second memory access commands is performed during an overlapping time period with fulfilling N−2 other memory access commands in relation to N−2 other memory banks in the memory device.

15. A non-transitory computer-readable storage medium comprising instructions that, when executed by a processing device, cause the processing device to:
receive a first memory access command that requests access to first data in a memory device;
determine a first location in the memory device for the first memory access command, wherein the first location for the first memory access command indicates a set of managed units in a first row of a first memory bank of the memory device; and
fulfill the first memory access command using the first data at the first location as a complete response to the first memory access command.

16. The non-transitory computer-readable storage medium of claim 15, wherein the memory device is divided into a set of memory parts, each memory part in the set of memory parts is subdivided into a set of memory banks, and each memory bank in the set of memory banks of each memory part is arranged into rows and columns of managed units.

17. The non-transitory computer-readable storage medium of claim 15, wherein the first memory access command is one of a read memory command or a write memory command.

18. The non-transitory computer-readable storage medium of claim 15, wherein fulfilling the first memory access command comprises:
activating the first row in the first memory bank;
accessing the first data in the first row of the first memory bank, wherein accessing the first data includes one of reading the first data from the first row or writing the first data to the first row; and
when the accessing includes reading the first data from the first row, including first user data and first parity data stored together in the first row, and returning the first data to a memory subsystem controller as the complete response to the first memory access command.

19. The non-transitory computer-readable storage medium of claim 18, wherein the processing device is further to:
receive a second memory access command that requests access to second data in the memory device;
determine a second location in the memory device for the second memory access command, wherein the second location for the second memory access command indicates a set of managed units in a second row of a second memory bank of the memory device; and
fulfill the second memory access command using the second data at the second location as a complete response to the second memory access command.

20. The non-transitory computer-readable storage medium of claim 19, wherein fulfilling the second memory access command comprises:
activating the second row in the second memory bank;
accessing the second data in the second row of the second memory bank, wherein accessing the second data includes one of reading the second data from the second row or writing the second data to the second row; and
when the accessing includes reading the second data from the second row, including second user data and second parity data stored together in the first row, and returning the second data to the memory subsystem controller as the complete response to the second memory access command,
wherein the memory device includes N memory banks and fulfilling the first and second memory access commands is performed during an overlapping time period with fulfilling N−2 other memory access commands in relation to N−2 other memory banks in the memory device.
